(19) United States
(12) Patent Application Publication
(10) Pub. No.: US 2009/0235813 A1
(43) Pub. Date: Sep. 24, 2009

(54) Ballistics Barrier

(76) Inventors: Arthur Henry Cashin, Nashville, TN (US); Sheldrick Faris Hawkins, Hermitage, TN (US); William McAdam Hawkins, Nashville, TN (US); Brian Andrew Hickie, Greenville, SC (US); Marc Douglass Verble, Gallatin, TN (US); Frank Lee Hollowell, JR., Signal Mountain, TN (US)

Correspondence Address: WADDEY & PATTERSON, P.C., 1600 DIVISION STREET, SUITE 500, NASHVILLE, TN, 37203, US

(21) Appl. No.: 12/053,966

(22) Filed: Mar. 24, 2008

(51) Int. Cl. F41H 5/00; B32B 7/00

(52) U.S. Cl. 89/36.02; 428/593; 89/36.07; 428/73

(57) ABSTRACT

A ballistics barrier having a multitude of vertically stacked layers. Each layer comprised of a plurality of horizontally-offset, interconnected laterally collapsible cells formed from multiple sheets of ballistics fabric. The perimeter interface between two vertically stacked layers is sealed by a skirt extending between the top of one layer and the bottom of the vertically adjacent layer.

### TECHNICAL FIELD

The present invention relates generally to ballistics barriers. More particularly, the present invention relates to ballistics barriers formed from geotextile materials, which provide a barrier that is readily portable, scalable, and possesses a structure that is optimized to dissipate the impact energy of a projectile.

### BACKGROUND OF THE INVENTION

Ballistics barriers provide a means to mitigate the damage caused by ballistic assaults. The prior art is replete with barriers and structures designed to resist or repel such assaults. Although ballistics barriers have numerous personal and commercial applications, most uses occur in military applications. In such applications, the use of the barrier may vary according to theater of conflict. In an urban environment the barrier may be used to enhance or supplement an existing structure's ballistic defenses. In an environment without significant pre-existing infrastructure, the barrier may, itself, constitute the whole of the structure or building. This includes environments like a desert where it is common for military personal to fabricate their own shelter because the barren landscape offers no natural or man-made alternatives.

However, regardless of the environment in which the ballistics barrier is used, an employable barrier must possess several key attributes: it must effectively protect persons or objects behind or within the barrier, it must be quick and easy to install and erect, and it must be readily transportable through rugged or otherwise difficult to traverse terrain. The prior art's myriad of ballistics barriers have achieved varying degrees of success when viewed in light of these key attributes.

For example, U.S. Pat. No. 4,822,657 issued to Simpson describes a bullet resistant panel having a rigid frame securing two exterior facing panels, preferably an aluminum or steel sheet, which bound a pair of cellulosic substrates. Adjacent one of the pair of cellulosic substrates and anchored to the frame is an impact resistant fabric such as Kevlar, and between the fabric and the other cellulosic substrate is an insulation layer. Simpson instructs that the bulk of the protection afforded by the assembly is attributable to the impact resistant fabric.

Norton, U.S. Pat. No. 4,198,454, discloses a lightweight projectile resistant composite panel for use in constructing a portal enclosure. The panel includes two metal plates forming the exterior walls, a honeycomb panel abutting one metal plate with the cell walls of the panel normal to that of the metal plate, an ablative material filling the honeycomb panel (designed to dissipate thermal energy), next to the honeycomb panel is a projectile resistant material comprised of a ceramic fibers or woven fabric, and between the projectile resistant material and the other metal plate is a thermal insulating material. Because only the outer plates are metal, Norton claims the composite panel is well suited to be transported to remote locations.

Another ballistics barrier is shown and described by White in U.S. Pat. No. 6,907,811. White teaches a barrier having a bullet-resistant base unit with wheels so that the barrier may be easily moved. Removably attached to, and vertically collinear with, the base unit is a transparent bullet-resistant shield so that the person or persons seeking refuge behind the shield can easily see through the shield.

Weatherwax, U.S. Pat. No. 7,159,503, describes an explosion protective shelter having a set of free standing walls without any rigid structural interconnection between them. The walls are comprised of a multitude of interlocking panels. Preferably, the vertical walls are engaged to a horizontal stabilizing platform in such a way that the walls are allowed to rotate about their engagement with the platform. Even more preferably, the tops of the walls are connected by springs and wires. Resultantly, if an explosive device is placed within the structure and detonates, the tops of the walls will deflect to absorb and direct the blast, as the non-rigid connection allows the walls to rotate outward about their pivot point (the engagement with the platform).

A ballistic barrier is described in Meeker, U.S. Application Publication No. 2006/0248827. Meeker provides for a barrier having two exterior panels composed of an elastomeric polymer, at least two rigid interior panels, and a quantity of earth material disposed between the interior rigid panels. Meeker instructs that as a projectile passes through the elastomeric polymer the polymer seals around the projectile and prevents fragmentation. The rigid interior panels and earth material serve to further impede, and eventually stop, the progress of the projectile.

Kramer, U.S. Application Publication No. 2007/0245933, provides a projectile resistant partition comprised of external cover plates arranged on stands. The cover plates bound internal bombardment plates which are at least partially made of plaster fiber materials, alleged to have superior strength and protection characteristics while being lighter than a comparably sized steel plate. Kramer instructs that this combination presents a projectile resistant partition.

The use of sandbags to form ballistics barriers is also well known in the prior art. Unfilled sandbags are portable and inexpensive. However, the use of sandbags to construct a ballistics barrier presents several problems. For instance, filling the sandbags is a labor-intensive process; typically one person holds the sandbag open while another person manually fills the bag. Further, time and effort must be dedicated to moving and arranging each individual sandbag to form a shelter. Lastly, sandbags lack the robustness needed to construct an effective ballistics barrier, i.e. they are easily torn or otherwise damaged.

Gabions, wire-metal frameworks, lined or wrapped with a geotextile material have been used in the past to provide shelter from ballistic assaults. These metal-wire structures provide the strength and resiliency to contain the earthen fill material while the geotextile wrapping prevents particulate fill material from escaping. Undesirably, when these barriers are struck by projectiles, the gabion(s) are prone to fragmentation—which creates dangerous shrapnel. Further, once the gabions have been structurally compromised they are difficult to repair and the bulky rigid frame defining the gabion is demanding to transport.

Unfortunately, the ballistics barriers of the prior art fail to provide a barrier that can easily collapse into a traveling form factor orders of magnitude smaller than its erected form (further, the traveling form factor of prior art barriers is not easily manipulated to be accommodable to disparate channels of transportation and/or storage media), a barrier that is scalable, a barrier that is economical to produce and deploy, and a barrier that can be expeditiously installed and erected (a vital attribute in a conflict setting). Thus, what is needed it a light-weight, versatile, and readily portable ballistics barrier that can leverage in-situ materials and terrain to provide an effective shelter from explosions or enemy fire.

### SUMMARY OF THE INVENTION

The present invention discloses a barrier uniquely capable of providing a collapsible, light-weight, resilient, and scalable means to thwart a ballistics assault. The inventive ballistics barrier, or rapid deployment wall, is comprised of a plurality of layers, each layer being defined by a collection of horizontally-offset, interconnected cells. The cells are formed from one or more sheets of fabric affixed together. Preferably the layers are formed from multiple sheets of fabric with the outermost sheets, i.e. the sheets that will form the exterior boundary of the layer, having a height greater than the interior sheets. Thus, a skirt is formed as a result of the height difference between the sheets, which spans the perimeter of the layer. When layers or units are stacked this inherently formed skirt serves to retain fill material deposited in the upper layer by preventing the fill from leaking out between the layers (as will be further discussed herein below).

The horizontally-offset cellular arrangement of the layers is created by affixing the sheets together at predetermined positions to create the desired honeycomb pattern. Although the sheets can be attached in a plethora of ways (such as by adhesives, staples, pins, retaining clips, etc.), the preferred method is by sewing. Joints formed in accordance with this method have a structural integrity similar to that of the fabric itself.

The sheets may be a high strength fabric, either woven or nonwoven. If woven, the present invention envisions any weave and natural or synthetic threads or yarns. If nonwoven, any nonwoven technology or polymer which meets a minimum of 100 lbs grab tensile (or grab tensile strength as determined by test method ASTM D4632) with a preferred range of above 300 lbs grab tensile (including woven materials, collectively referred to a “ballistics fabric” herein after). Preferably, the fabric is a polypropylene-based, non-woven material geotextile. Such a material is known to be puncture and tear resistant, flexible, possess a high tensile strength, and to be stiff enough to form, and maintain, a framework without the aid of any external braces or supports, especially important for avoiding the creation of shrapnel or other flying debris. TYPAR®, manufactured by Fiberweb, plc. is one such material. One desirable aspect of TYPAR material is that it has a high TEA (total energy absorbed) per unit weight, especially as compared to materials such needle-punched fabrics which may have comparable tensile strengths. However, in addition to those mentioned above, other materials are also envisioned by the present invention, these materials include non-polypropylene based non-wovens, composite wovens, HDPE (high-density polyethelenes), polyethylene terephthalate, KEVLAR® material, and scrims reinforced fabrics. Advantageously, the non-rigid nature of the fabric, particularly a geotextile, permits the barrier of the present invention to stretch and conform to the topology of the surrounding environment. For instance, if a barrier is placed on or across a curved surface, e.g. a hill or valley, the present invention can conform to the surface topology to provide complete coverage. In contrast, if a barrier constructed of gabions were deployed across this same surface, the inflexible cages would not readily conform to the surface and would be susceptible to attacks concentrated on the regions of the barrier that did not intimately follow the contours of the surface. Further, the gabions, which have regions that do not follow the surface contours, would also be prone to fail or become ineffective due to particulate fill material leaking from the non-contoured regions.

Once a foundation layer has been erected, the cells are packed with a fill material. Most often the fill material will be soil, sand, or rocks. Indeed, when the fill material is soil, plants can be encouraged to grow on and in the inventive ballistics barrier, both for aesthetic reasons, and because the root system of plants may provide increased stablility to a multi-layer barrier. However, any fill material that will assist to dissipate a projectile's energy is envisioned by the invention.

Packing the cells can be expedited by utilizing a front end loader, a back hoe, a conveyor apparatus, or the like. Because the layer is a matrix of interconnected cells, and the geotextile fabric is self-supporting, large amounts of fill material may be deposited in multiple cells at once with a single effort. Additionally, a light-weight rigid framework may be employed to facilitate the filling process. Such a framework may be coextensive with the perimeter of the barrier and couple to some or all of the cells comprising the barrier's perimeter. This would allow the framework to provide tension across the plurality of cells to encourage the cells into their most exposed, i.e. open, position thereby facilitating the packing/filling process. Further, the framework may be constructed from a set of readily transportable rods or constituent members that interconnect to form the composite framework. Once a frame has been erected and attached to the barrier, the frame may be used to move a layer of the barrier into a desired position. Alternatively, the framework may be sized to hold open a single cell. Such a frame would be compact yet provide a single individual with the ability to easily transport and deploy the frame. However, the present invention is not limited to the frames described herein, the present invention also envisions any technique or apparatus that opens the cells to aid in packing, e.g. tensioning opposing corners/sections of the barrier by manual effort or tie downs. Compared with the individualized packing process associated with, for instance, prior art sandbags, the present invention permits a mass packing effort-thereby significantly reducing the time required to construct the barrier. As subsequent layers are positioned on the layers below, a similar filling process occurs.

As briefly mentioned above, each layer of interconnected cells may also have a perimeter skirt or apron (as would be inherently formed by providing the external sheets of geotextile material comprising the layer with a greater height than the internal sheets). The skirt functions to effectively connect one layer to the next to provide rigidity and prevent any fill material deposited in the cells of the higher layer from escaping at the layer-to-layer junction with the lower layer. If neither layer has an integral skirt, one can be affixed to the interface between the lower and upper layers after the layers have been stacked. The skirt will extend around all or a portion of the exterior perimeter of the layers to create an overlap joint without any functional discontinuities. This process may be repeated for additional layers until a desired height is reached.

The present invention serves to protect persons from a ballistics assault through two primary mechanisms. Firstly, the fill material dissipates the kinetic energy of the projectile or blast wave as it travels through the fill material and the geotextile fabric defining the cell walls. Common in-situ fill material is sand, soil, and/or rocks. Secondly, the unique horizontally-offset cellular arrangement of the invention provides walls that function as shear absorbing boundaries as they are acted upon by the advancing blast waves, scatters the blast waves, and provides a medium through which reflected waves may travel and dissipate. As will be discussed below, the ability to dissipate the blast waves by way of attenuation and scattering is of paramount concern in ballistics barriers.

When a projectile and/or a blast wave from an explosion strikes the barrier, pressure waves are created that travel through the barrier (from the front to the back relative to the projectile's initial engagement with the barrier). The blast or pressure waves are attenuated by the fill material. However, the fill material transmits a portion of the forces created by the pressure waves to the fabric interface, e.g. the ballistics fabric, between the cells. The fabric interface both dissipates and scatters/redirects the pressure wave. The ballistics fabric material (such as TYPAR) dissipates the pressure wave because the ballistics fabric is a shear-absorbing material. Thus, as the pressure waves encounter the cell walls a significant portion of pressure wave energy is absorbed by the ballistics fabric. Further, as a result of the unique cellular structure and arrangement of the present invention, the cell walls also serve to interrupt and redirect the pressure waves as they travel through the barrier. In sum, the barrier, via the arrangement and composition of the cells, both absorbs and redirects incident pressure waves (this is in addition to the attenuating effects of the fill material in the cells). In the case of a projectile striking the barrier, the present invention encourages the projectile to fragment (by the projectile's interaction with the fill material). This fragmentation serves to dissipate the penetrating capabilities of the projectile.

If a residual pressure wave reaches the fabric at the back of the last filled cell or row of cells, there will be no relatively dense fill material on the other side of the interface for the blast wave to travel through. When this occurs, the pressure wave impacts and distorts/deforms the fabric itself. To effectively manage this situation, the fabric must have sufficient tensile strength to absorb this force and reflect it back in the opposite direction as a tensile stress wave. If the cellular structure were not there to accept and reflect the forces then the energy carried by the pressure wave would completely dissipate when it encountered the back of the barrier. This dissipation is manifested in the form of a dynamic energy release. Such an energy release can be very destructive. The spalling of the back side of a concrete wall as a result of an impact to the front side is one such manifestation of this type of destructive energy release. However, merely reflecting the tensile stress wave does not alleviate the problem. There must also be a conduit through which the tensile stress wave can travel back through the barrier. In most applications, the fill material will not readily accept the tensile wave. Advantageously, the ballistics fabric defining the cells will readily accept the tensile wave and allow the wave to travel back through the barrier and further dissipate.

Consequently, it is desired to have a barrier to accept, reflect, and dissipate the forces generated from an explosion or ballistics assault. The ballistics fabric serves this role in the invention. Thus, the present invention dissipates the kinetic energy of the projectile and/or explosion and provides a medium through which blast waves may travel, and hence dissipate. In this way, the present invention effectively suppresses the damage caused from a ballistics assault or explosion.

Accordingly, it is an object of the present invention to provide a light weight ballistics barrier that can be easily transported and/or stored.

Further, it is another object of the present invention to provide a barrier that a single person can transport and erect.

It is another object of the present invention to provide a ballistics barrier that can be expeditiously installed and erected.

Still another object of the present invention is a ballistics barrier which effectively dissipates forces resultant from a projectile impinging on the barrier.

Yet another object of the present invention is a ballistics barrier that is economical to fabricate and use.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operations of the invention.

### BRIEF DESCRIPTION OF THE DRAWINGS

FIG. 1 is a perspective view of one embodiment of the present invention.

FIG. 2 is a side view of a ballistics barrier having a protective covering.

FIGS. 3a-b are top views of a T-3 and T-4 configuration, respectively.

FIGS. 4a-d shows the process of forming cells from multiple sheets of ballistics fabric.

FIG. 5 is a top view of a partially collapsed layer of the present invention.

FIG. 6 is a side view of the present invention showing the stabilizing flange(s).

FIG. 7 is a side view of one embodiment of a multi-layered cellular system.

FIG. 8 is a perspective view of the present invention detailing the skirt.

FIG. 9 is an end view of the five ballistics fabric sheets used to fabricate a T-2 barrier showing the height difference between the sheets.

FIG. 10 is a top view of a ⅔ offset ballistics barrier.

### DETAILED DESCRIPTION OF THE PREFERRED EMBODIMENTS

Ballistics barriers (or rapid deployment walls) are used extensively throughout any military conflict. These barriers may serve as a temporary refuge from enemy fire or as a quasi-permanent shelter from which conflict participants may direct the military campaign. Irrespective of the use, the barriers must be scalable; effective; easy to store, transport and erect; economical to manufacture; and versatile.

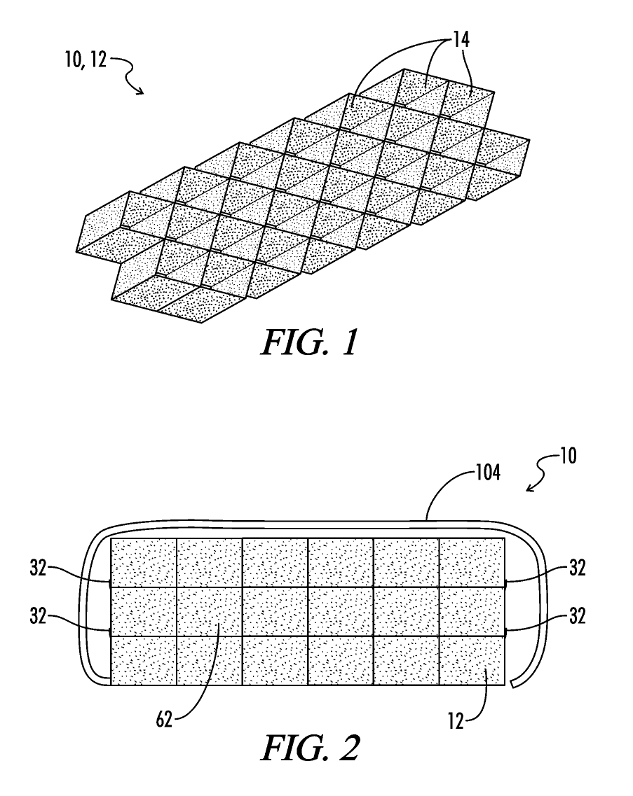

The present invention provides a ballistics barrier that satisfies all of the aforementioned aims. Referring to FIG. 1, ballistics barrier 10 has a first layer 12, also referred to as a first array 12 or a foundation layer 12. Layer 12 is comprised of a plurality of horizontally-offset, interconnected cells 14. The cells 14 are formed from a multitude of ballistics fabric sheets that are aligned and then affixed together at predetermined intervals to create the desired cellular structure.

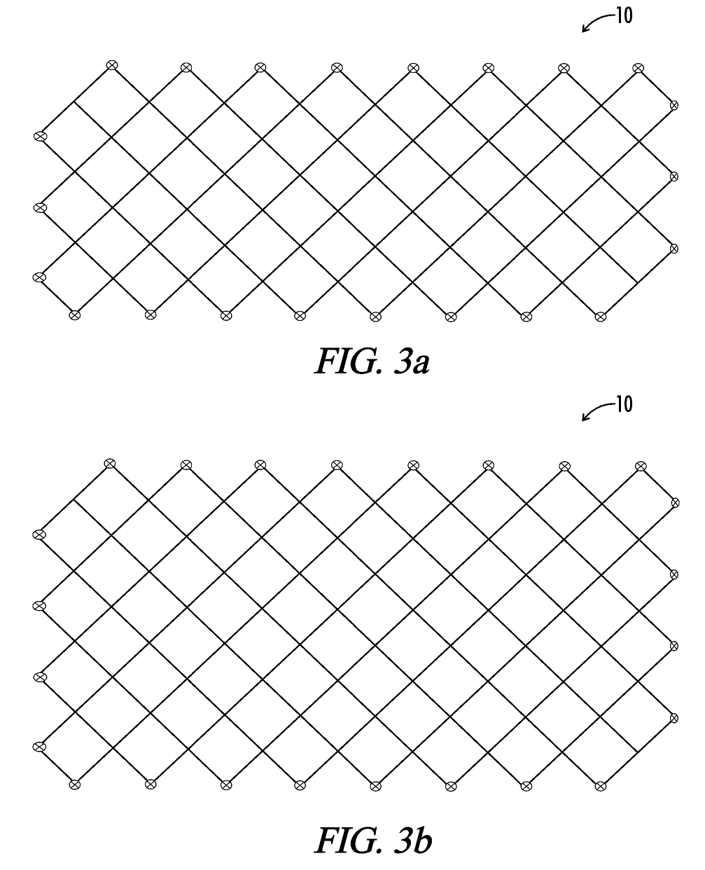

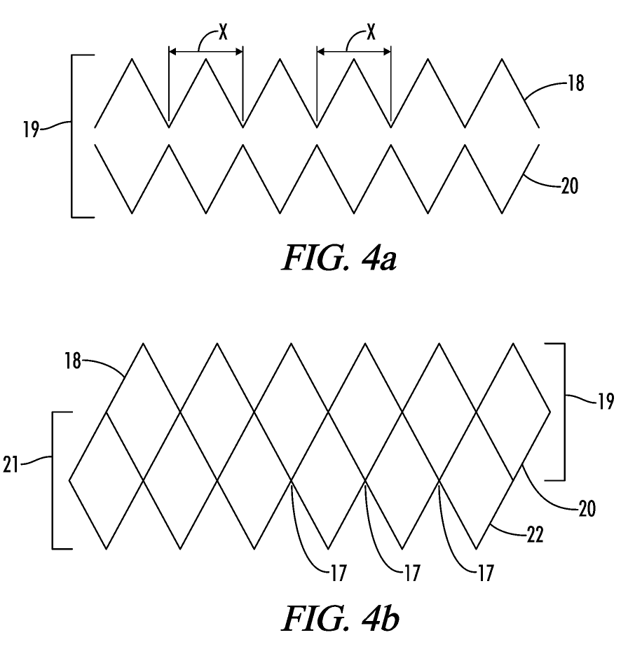

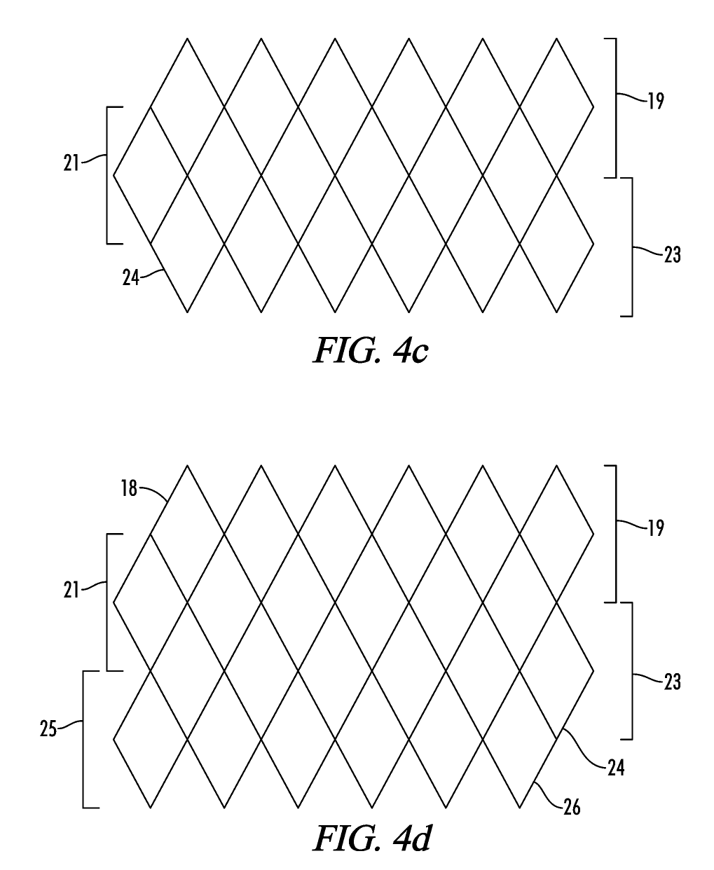

For illustrative purposes, consider the exaggerated fabrication sequence illustrated in FIGS. 4a-4d. FIG. 4a shows two pieces of ballistics fabric 18 and 20 being sewn together at interval X to create a row of cells 19. Next, as shown in FIG. 4b, another sheet of fabric 22 is sewn to the first row of cells at locations corresponding to the first rows' vertices 17 (presupposing the first row has assumed a diamond shape) to create a horizontally offset, relative to the first row, second row of cells 21. FIG. 4c shows a fourth sheet of fabric 24 sewn to the third sheet 22 to create yet another row of offset cells 23. Finally, in FIG. 4d a fifth sheet 26 is sewn to the third row of cells (the fourth sheet 24) to create a fourth row of cells 25. The arrangement depicted in FIG. 4d is referred to as a T-2 configuration because an object (such as a projectile) would have to traverse at least two cells regardless of where on the face of the barrier it strikes. For ease of implementation, the actual manufacturing process is affected with the sheets of ballistics fabric oriented in a substantially parallel relationship, i.e. not distended into any particular shape-like the diamond shape of FIGS. 4a-d. FIGS. 3a-b show a T-3 (six rows of cells, requiring an object to traverse at least three cells regardless of where on the face of the barrier it strikes) and T-4 (eight rows of cells, requiring an object to traverse at least four cells regardless of where on the face of the barrier it strikes) arrangement, respectively.

It will now be obvious to one of ordinary skill in the art that more cells and rows can be added and that the dimensions of the resulting array can be manipulated to achieve a desired size and/or shape. It should also be noted that while FIGS. 4a-4d illustrate a diamond-shaped cell, other cell configurations are within the scope of the invention, such as triangular or rectangular-shaped cells. Alternative barrier arrangements can be created by varying the size and coupling points of the ballistics fabric sheets used to fabricate the barrier or by cutting/shaping standard barriers configurations with, for example, a shearing tool. Further, the cell shape may be distorted as a cell is packed with fill material, especially if the cell is on the perimeter of the barrier. Thus, an exterior diamond-shaped cell may actually have significant curvature after the cell has been packed. This distortion does not compromise the effectiveness of the present invention and is an artifact of the filling/packing process.

Preferably, the exterior sheets 18 and 26 would have a height greater than the interior sheets 20, 22, and 24. This relationship is clearly presented in FIG. 9. In one preferred embodiment, the exterior sheets 18 and 26 have a height of twenty-four inches while the interior sheets 20, 22, and 24 have a height of twenty inches. After assembly, this height difference provides a skirt 32 or connecting member 32 around the perimeter of the layer.

Although the preferred embodiment of the present invention utilizes multiple sheets of fabric, similar cell structures could also be made from a continuous sheet of ballistics fabric. This could be accomplished by folding the ballistics fabric back and forth on itself and bonding the opposing segments at predetermined intervals.

The ballistics barrier of the present invention is endowed with the ability to effectively disperse and attenuate pressure or blast waves because of the interconnected cellular arrangement of the layers and the resilient characteristics of the ballistics fabric material used in the fabrication process. As discussed in the Background section, dispersing and attenuating pressure waves significantly reduces the destructive effects of a projectile or explosion acting on the barrier. It should also be noted that in the preferred embodiments of the present invention, the horizontally offset cellular structure inherent in the above described fabrication process, provides a barrier that presents a uniform front against ballistics assaults. Specifically, preferred embodiments of the barrier will be fabricated such that any blast wave or projectile must breach the same number of cells to compromise the barrier regardless of where the impact occurs (of course, depending on the trajectory of the impact/blast more cells may be involved). Providing a uniform front maximizes the protective capabilities of the barrier while minimizing the size and weight of the barrier (crucial concerns for portability).

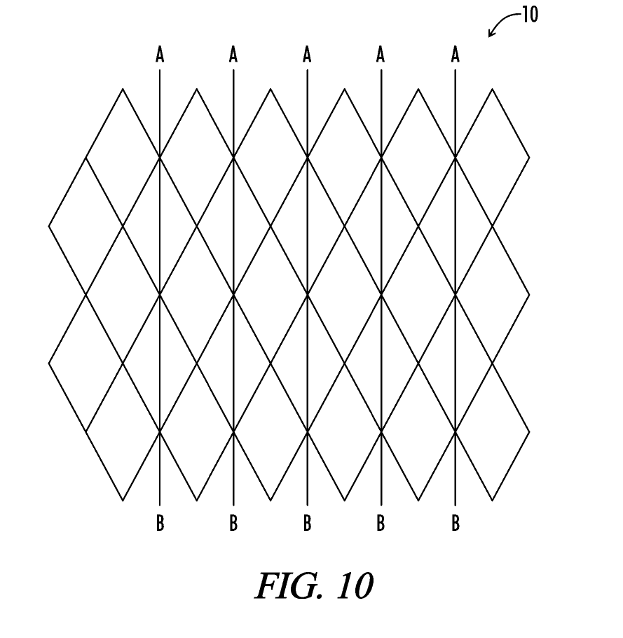

For instance, a preferred embodiment illustrated in FIG. 4d shows a ballistics barrier with a T-2 configuration. With such a cellular arrangement, any projectile or blast wave would have to survive the damping effects of at least two cells before any significant damage could be imparted to persons or objects sheltered behind the barrier. This type of configuration provides an ideal balance between protective attributes and weight/size. For example, two T-2 units, fabricated in accordance with the present invention, provide a barrier about five meters long, about one meter wide and over one meter high. Further, such a barrier can weigh forty pounds or less (unfilled) depending on the material used—very manageable for a single person to transport, even across rugged terrain. Comparatively, if the barrier had an arrangement such as that shown in FIG. 10, and referred to as an offset ⅔, no significant protective advantages would be had as compared to the T-2 because the offset ⅔ only provides two cells worth of protection along the lines defined between points A and B. Thus, the additional material used to construct the offset ⅔ makes the barrier more costly, more bulky, and heavier with few benefits over the T-2.

Desirably, a ballistics fabric comprises the cell walls, and more generally layer 12 in its entirety, and occupies a vital role in the performance of the present invention. The ballistics fabric may be a woven, knitted, or non-woven fibrous web. The ballistics fabric may be a polypropylene-based non-woven geotextile material. In some embodiments, the geotextile comprises about 60% to about 80% polypropylene and about 20% to about 40% polyethylene. However, in the preferred embodiment, the geotextile is comprised entirely from polypropylene (exclusive of impurities). One such material is TYPAR, available from Fiberweb plc. of Old Hickory, Tenn. TYPAR is a high strength non-woven fabric manufactured using highly oriented individual polyolefin fibers. Desirably, these fibers are between about three and thirty Denier (a unit of weight indicating the fineness of fiber filaments) and even more desirably between about eight and twenty-two Denier. This composition would imbue the geotextile with resistance to naturally occurring soil alkalis and acids (of great import if the fill material is soil). Additionally, the geotextile would be unaffected by bacteria or fungi. Because, in most applications, the geotextile will be exposed to sunlight, and its harmful ultraviolet (UV) radiation, the geotextile may be made from fibers that contain ultraviolet and anti-oxidant additives or be coated with an UV resistant coating to improve the life of the material. As it is often desirable for a ballistics barrier to be camouflaged, the geotextile is receptive to pigmentation, coloring, and dying. Thus, the present invention envisions a camouflaged barrier that reduces the visual footprint of the barrier. The camouflaged pattern may be matched to the environment in which the barrier will be deployed.

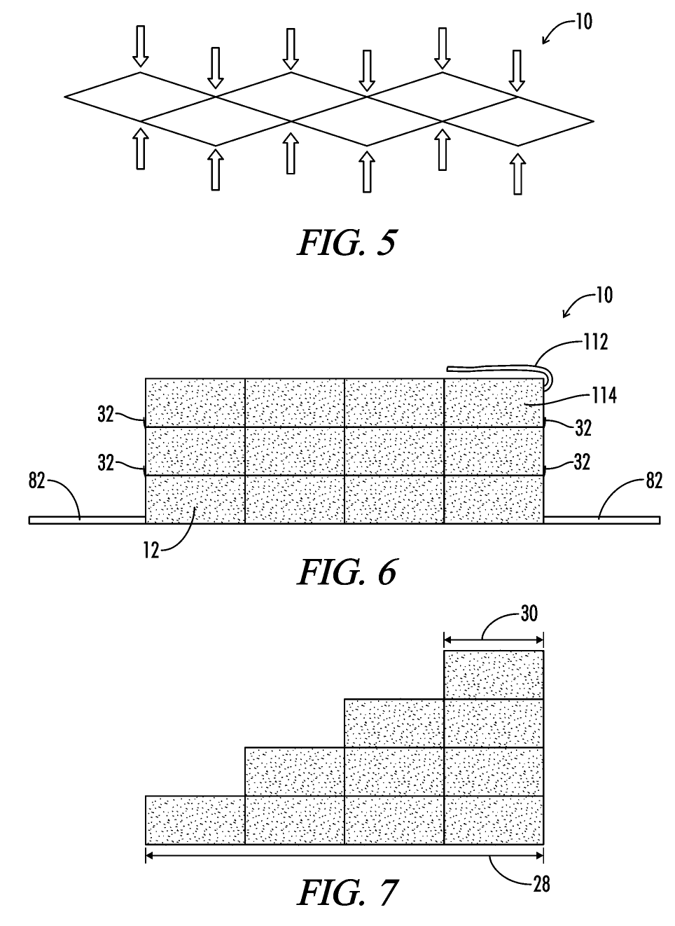

Advantageously cells constructed in the above-described manner are laterally collapsible. Consider that the cells are formed from a non-rigid fabric and the formation of the cells is only a consequence of the bonding of sheets of fabric together at certain points. Because the fabric is pliable and no rigid framework supports the layer 12, the layer 12 may be collapsed, for example, by encouraging in unison opposing vertices of a cell (in the context of diamond-shaped cells) toward each other as illustrated in FIG. 5. After the layer 12 has been laterally collapsed, it may also be manipulated into a different form-factor, e.g. the layer 12 may be rolled or folded into a form-factor more amenable to transportation or storage, often referred to as a low logistical footprint. In one preferred embodiment, the barrier has a volume ratio, the ratio of an erected, filled barrier to that of a collapsed and packaged barrier, from about 40:1 to 100:1, with the preferred ratios ranging from approximately 70:1 to 100:1.

Geotextile cellular systems are well known in the prior art, such as that described by Roland in French Publication No. FR2824340 and Vignon et al in U.S. Pat. No. 4,572,705. Furthermore, geotextile cellular systems having multiple levels are also well known. However, multi-level systems disclosed in the prior art fail to provide a mechanism that allows vertical stacking with fine particulate fill material (as would be used to fill a ballistics barrier in a desert or other arid environment). The prior art teaches a first layer with a first area and a second layer stacked on the first layer, the second layer having an area less than the first area. In essence, the area of each additional layer is reduced or receded to minimize the escape of particulate fill material through the perimeter interface between two adjacent layers by providing a landing on which the fill material can collect—thereby creating an obstruction for other fill material attempting to leave the barrier. Thus, to create a multi-layered structure employing particulate fill material, the prior art must utilize a pyramidal arrangement (an exemplary pyramidal configuration is shown in FIG. 7).

However, this is undesirable for many reasons. One such reason is that additional time, effort, and material must be expended to construct a wall that has a footprint 28 significantly larger than the thickness of the wall at the highest layer 30, as shown in FIG. 7. It would be desirable to have a ballistics barrier with a uniform wall thickness so that the barrier could be quickly erected with minimal effort and material. The present invention meets this need.

The ballistics barrier of the present invention is readily scalable to a multi-layered barrier by providing a structure that can accommodate numerous vertically stacked layers, as shown in FIG. 2, without resorting to the pyramidal design of the prior art. Moreover, the present invention provides these capabilities even with fine particulate fill material. Nevertheless, if a specific need arises for a vertically-stepped barrier, the present invention can easily be configured in such a topology.

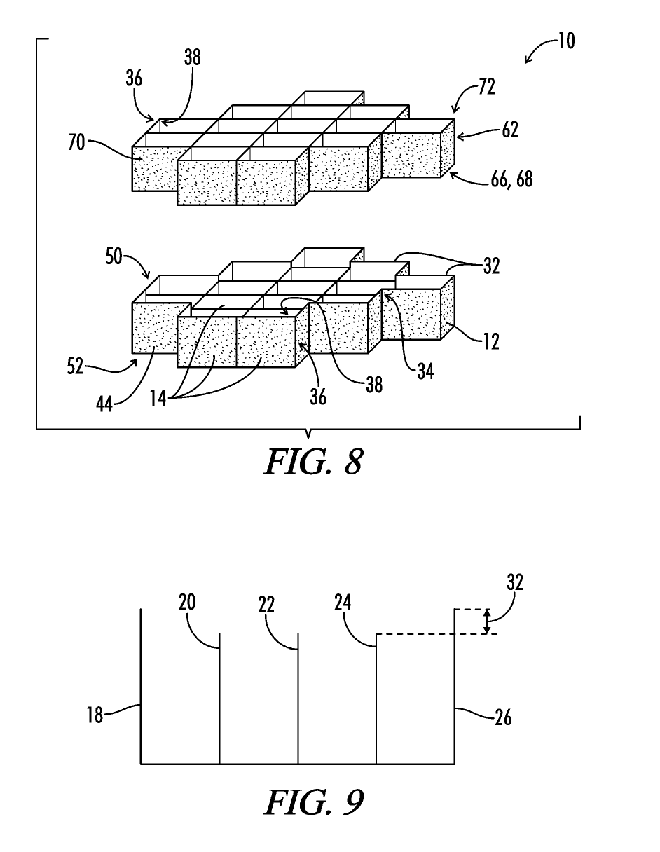

Referring now to FIG. 8, the barrier 10 includes an integral skirt 32 or connecting member 32, although in some embodiments the skirt 32 may be a distinct component separately attached to the barrier 10. Preferably, the skirt 32 is comprised of the same ballistics fabric as the barrier 10 and results from the height difference between the exterior and interior sheets of ballistics fabric used to form the layer, as detailed above.

Layer 12 has a body 44 or foundation body 44 defined between a top side 50 and a bottom side 52, as shown in FIG. 8. The body 44 is primarily formed by the cell walls, which, in turn, are created as the ballistics fabric sheets are affixed together. The height of the body 44 directly correlates to the width of the ballistics fabric material used to fabricate the layer, in this case layer 12. In one embodiment the skirt 32 is attached to the top side 50 of layer 12 proximate the perimeter 34 such that the skirt 32 extends beyond the body 44 of layer 12. The perimeter 34, or first perimeter edge or first periphery 34, can also be described as the external portion of each cell wall not engaged to another cell within the same layer (although in some embodiments the skirt 32 may also be engaged to the interior cells or internal walls of the array).

Desirably, the cells 14 have open ends to facilitate packing the cells 14 with fill material and, later unpacking the cells 14. It is also envisioned that the cells 14 may have a covering 112 (as shown in FIG. 6 attached to layer 114) foldably attached to the body 44 proximate the top side 50 so that the covering can fold over and secure the fill material in the cells 14. A covering may also be attached to any layers subsequently stacked on top of layer 12 to serve the same purpose, i.e. to secure the fill material.

FIG. 8 also depicts a second layer 62, also referred to as a second array 62 or expansion layer 62, formed in a similar manner to that of layer 12. Layer 62 has an expansion body 70 defined between a lower side 68 with a lower perimeter 66, or second perimeter edge portion or periphery 66, and an upper side 72. Thus, when layer 62 is stacked on top of layer 12 the skirt 32 will overlap the lower perimeter 66 of layer 62 or, alternatively worded, the skirt 32 extends up over a portion of the body 70 of layer 62, as is indicated in FIG. 8. After layer 62 has been positioned on layer 12 the skirt 32 can then be coupled to layer 62 to form a seal between the two layers 12 and 62 so that fill material cannot escape through the interface between layers 12 and 62. However, the skirt 32 need not be mechanically coupled to layer 62 to be effective. Rather, the engagement between the two layers 12 and 62 and the resultant positioning of the skirt 32 proximate the perimeter of layer 62 serves to deter fill material from escaping from the layer-to-layer interface.

Although the ballistics barrier 10 of the present invention has been described with the skirt 32 initially attached to the lower layer 12, the invention is not so limited. It will also be readily apparent to one skilled in the art that the skirt 32 could easily be affixed, or integral, to layer 62 rather than the layer 12. In this embodiment, the skirt 32 may be proximate the lower perimeter 66. Further, as previously mentioned the skirt 32 could be a separate component and positioned and secured to the layers 12 and 62 after they have been stacked. In such a configuration the skirt 32 would preferably be attached to the layers 12 and 62 by a mechanical fastener, such as a rivet, (if not integral to one of the layers as in the preferred embodiment); however, the skirt 32 can also be attached by stapling, taping, clipping, sewing, adhesives, or the like.

If the skirt 32 is not integral to one of the layers then the present invention also envisions that the skirt 32 may be coupled to the external surfaces 36 or the internal surfaces 38 of the two layers 12 and 62; specifically, external and internal surfaces 36 and 38 of the first and second perimeter edge portions 34 and 66. Further, by varying the height and/or positioning of the skirt 32 the amount of overlap covering layers 12 and 62 can be controlled. Providing more overlap can increase the rigidity of the ballistic barrier 10, although at the expense of requiring more material.

In addition to providing a mechanism to prevent fill material from escaping, the skirt 32 also functions to strengthen the multi-layered barrier, as briefly mentioned above, by providing an exterior surface that does not have any significant discontinuities, or at the very least reducing the number of potential structural failure points.

The ballistics barrier 10 may also have a stabilization flange 82 connected to the bottom perimeter of layer 12 and extending out away from the layer 12 as shown in FIG. 6. The stabilization flange 82 can be staked, or otherwise affixed to the surrounding terrain, to provide stability to the barrier 10 against lateral movements, such as those caused by winds or other external factors. The stabilization flange 82 can also be the result of inverting a layer so that the skirt 32 is proximate the ground; however, the stabilization flange 82 may also be a separate component and used in conjunction with a non-inverted layer having s skirt 32.

FIG. 2 shows an embodiment of the present invention having a protective cover 104 coupled to the ballistics barrier 10, particularly to the first layer 12 or a portion of the first layer 12. Desirably, the protective cover 104 is made from a geotextile fabric that allows the cover 104 to be durable and flexible. In one preferred embodiment the protective cover 104 has a height greater than the combined height of the first and second layers 12 and 62. Even more preferably, the protective covering 104 is sized to allow it to envelop the entire barrier 10, thereby preventing fill material from leaving the barrier 10. The portion of the cover 104 that is not initially attached to layer 12 can be pulled over the barrier 10 and then secured to another portion of the barrier 10 by mechanical fasteners. The protective cover 104 may be integral to layer 12 or may be a separate component that is affixed to the layer 12 or to the area proximate the layer. Such a cover may be vital to prevent fill material from being ejected or removed from the barrier 10 during the course of an impact, explosion, or as a result of high winds.

Although a ballistics barrier having two layers has been extensively discussed, it is obvious to one of ordinary skill that the invention can be extended to erect a barrier with three or more layers.

All cited patents, patent applications and publications referred to herein are incorporated by reference.

Thus, although there have been described particular embodiments of the present invention of a new and useful Ballistics Barrier, it is not intended that such references be construed as limitations upon the scope of this invention except as set forth in the following claims.

What is claimed is:

1. A rapid deployment wall, comprising:
a first plurality of horizontally-offset, interconnected, laterally collapsible cells defining a first layer, wherein the first layer comprises a first perimeter edge portion; and
a second plurality of horizontally-offset, interconnected, laterally collapsible cells defining a second layer, wherein the second layer comprises a second perimeter edge portion; and wherein the first and second plurality of cells comprise a ballistics fabric, and further wherein one of the first and second perimeter edge portions comprises a connecting member sealably engaged to the other of the first and second perimeter edge portions so that the connecting member creates a seal between at least a portion of the vertically stacked first and second layers.

2. The wall of claim 1 wherein the connecting member is a ballistics fabric.

3. The wall of claim 1 wherein each of the first and second perimeter edge portions has an interior surface and the connecting member is engaged to the interior surfaces of the first and second perimeter edge portions.

4. The wall of claim 1 wherein each of the first and second perimeter edge portions has an exterior surface and the connecting member is engaged to the exterior surfaces of the first and second perimeter edge portions.

5. The wall of claim 1 wherein the first plurality of cells is formed from more than one sheet of ballistics fabric.

6. The wall of claim 1 wherein the first plurality of cells comprises an exterior ballistics fabric sheet having a first height and an interior ballistics fabric sheet having a second height less than the first height.

7. The wall of claim 1, further comprising a non-rigid protective cover coupled to the first layer, wherein the first layer and second layer each have a height and the covering has a height greater than the combined height of the first and second layers.

8. The wall of claim 1 wherein the ballistics fabric is a geotextile material.

9. A ballistics barrier, comprising:
a first honeycombed array comprising a first plurality of open cells and a first periphery with an exterior surface, wherein the first array is laterally collapsible and the first plurality of cells comprises a ballistics fabric;
a second honeycombed array comprising a second plurality of open cells and a second periphery with an exterior surface, wherein the second array is laterally collapsible and the second plurality of cells comprises a ballistics fabric; and
a skirt engaged between the exterior surface of the first periphery and the exterior surface of the second periphery.

10. The barrier of claim 9 wherein the first plurality of cells is formed from multiple pieces of ballistics fabric and the second plurality of cells is formed from multiple pieces of ballistics fabric.

11. The barrier of claim 10 wherein each of the multiple pieces of ballistics fabric forming the first and second plurality of cells has a height and at least two of the multiple pieces of ballistics fabric have different heights.

12. The barrier of claim 9, further comprising a protective cover foldably engaged to the first honeycombed array, the first array having a height and the cover having a height greater than the height of the first array.

13. The barrier of claim 9 wherein the skirt is comprised of ballistics fabric.

14. The barrier of claim 13 wherein the skirt is integral to the first periphery.

15. The barrier of claim 14 wherein the skirt is engaged to the second periphery by mechanical fasteners.

16. The barrier of claim 9 wherein the ballistics fabric comprises a geotextile material.

17. A portable ballistics barrier, comprising:
a foundation layer comprising a first plurality of horizontally staggered, collapsible cells formed from multiple sheets of ballistics fabric; wherein the foundation layer has a top side with a top perimeter, a bottom side distal the top side, and a foundation body defined therebetween, and further wherein the foundation layer comprises a connecting member attached to the foundation body proximate the top perimeter and projects out beyond the foundation body away from the bottom side; and
an expansion layer comprising a second plurality of horizontally staggered, collapsible cells formed from multiple sheets of ballistics fabric; wherein the expansion layer has an lower side with a lower perimeter, an upper side opposite the lower side, and an expansion body defined therebetween, and further wherein the lower side of the expansion layer engages the top side of the foundation layer and the connecting member overlaps and engages the expansion body proximate the lower perimeter.

18. The portable barrier of claim 17 wherein the connecting member is a ballistics fabric.

19. The portable barrier of claim 17 wherein the each of the multiple sheets of ballistics fabric forming the cells of the foundation layer has a height and at least two of the sheets have different heights.

20. The portable barrier of claim 17 wherein the bottom side of the foundation layer comprises a bottom perimeter, opposite the top perimeter, with a stabilization flange extending away from the foundation layer.

21. The portable barrier of claim 17 wherein the multiple sheets forming the foundation layer are mechanically fastened together.

22. The portable barrier of claim 17 wherein the expansion layer comprises a covering foldably attached to the expansion body proximate the upper side.

23. The portable barrier of claim 17 wherein the foundation layer has a camouflaged pattern.

24. The portable barrier of claim 17 wherein the expansion layer has a camouflaged pattern.

25. The portable barrier of claim 17 wherein the foundation layer and the expansion layer have camouflaged patterns.

26. The portable barrier of claim 17 wherein the ballistics fabric comprises a geotextile material.
